(19) United States
(12) Patent Application Publication
(10) Pub. No.: US 2011/0000795 A1
(43) Pub. Date: Jan. 6, 2011

(54) ELECTROCHEMICAL DATA REJECTION METHODOLOGY

(76) Inventors: Kevin Lorimer, Abingdon (GB); Nigel Carter, Didcot (GB); Andrew Allan, Banbury (GB); Howard Orman, Abingdon (GB)

Correspondence Address: ROCHE DIAGNOSTICS OPERATIONS INC., 9115 Hague Road, Indianapolis, IN, 46250-0457, US

(21) Appl. No.: 12/638,323

(22) Filed: Dec. 15, 2009

Related U.S. Application Data
(63) Continuation of application No. PCT/GB2008/002074, filed on Jun. 18, 2008.

(30) Foreign Application Priority Data
Jun. 18, 2007 (GB) 0711780.7

(51) Int. Cl. G01N 27/26; G01N 27/403; G06F 19/00

(52) U.S. Cl. 205/775; 204/406; 702/23

(57) ABSTRACT

A method is provided for determining the concentration of an analyte in a sample which comprises: a) performing an electrochemical test comprising: (i) contacting the sample with an electrochemical cell comprising at least two electrodes; and (ii) obtaining at least one group of three or more measurements of an electrochemical parameter from the cell, wherein each measurement in each at least one group is obtained at a different time; b) deriving from said at least one group of three or more measurements a single value that is indicative of the time-dependent behavior of the measured parameter; c) comparing the single value indicative of the time-dependent behavior of the measured parameter with a pre-determined range of acceptable time-dependent behaviors; d) determining whether the test is acceptable based on the result of said comparison; e) optionally repeating the above-mentioned steps; and 0 determining the concentration of the analyte from the measurements obtained from the acceptable test or acceptable tests. Also provided is a device on which such a method can be performed and a computer program suitable for performing the data rejection methodology comprised in the method.

### CLAIM OF PRIORITY

The present application is a continuation application based on and claiming priority to PCT Application No. PCT/GB08/002074, filed Jun. 18, 2008, which claims the priority benefit of British Application No. GB 0711780.7, filed Jun. 18, 2007, each of which are hereby incorporated by reference in their entireties.

### TECHNICAL FIELD OF THE INVENTION

The present invention relates to methods for determining the concentration of an analyte in a sample by electrochemical measurements that are subjected to a data rejection methodology. The invention also relates to an electrochemical device and to a computer program for use in such methods.

### BACKGROUND

Electrochemical methodology is used for the detection of various parameters of a substance. For example, electrochemical methodology may he used to detect the presence or measure the concentration of a particular analyte in a test sample.

Measurement of the concentration of an analyte in a sample using an electrochemical cell may involve obtaining a measurement of an electrochemical parameter and comparing that measurement with results obtained on samples comprising known analyte concentrations. One means of determining an analyte concentration involves applying a potential difference across an electrochemical cell and making a measurement of the resulting current. In one such method according to WO2006030170, a time-varying potential is applied to step the potential applied across two electrodes in electrical contact with a target solution between an initial and a final potential. Once the final potential has been substantially attained, the current flowing between the electrodes is then sampled. It has been found that measurements of this type can reduce errors associated with the current spikes formed when step potentials are applied to the electrodes.

However, it has been found that electrochemical measurements of concentrations can still suffer from errors, for example through inherent analytical errors, misuse of the electrochemical apparatus (application of an incorrect sample, variations in sample volume, and so on) or faults in the physical or chemical format of the electrochemical apparatus. As the concentration in such a test is initially unknown, ii is not possible to determine whether a measurement is faulty simply by considering the magnitude of the measurement alone, provided it returns a result lying within a physically reasonable range. Thus, there is a need for a means of electrochemically assessing an analyte concentration that enables a user to determine whether the measured concentration is reliable.

It has been recognized that errors that can be introduced into assay results where particular measurements of an electrochemical parameter do not behave as expected owing to problems in the manufactured measuring apparatus (for example, a biosensor). U.S. Pat. No. 5,243,516 discusses errors of this type in electrochemical systems in which the measured current as a function of time should, under correct operating conditions, conform to the Cottrell equation. Such errors could arise, for example, where the effective electrode area changes over time due to commencing an assay before the sample has completely filled the cell, or alternatively where the electrode surface is hydrated, but not correctly covered with sample. U.S. Pat. No. 5,243,516 teaches that such errors can be detected by obtaining two measurements spaced around 500 ms apart and comparing the ratio of these measurements to that predicted by the Cottrell equation.

It has now been found that the approach taught in U.S. Pat. No. 5,243,516, which is based on the Cottrell equation, is ineffective in detecting errors in recently developed assays designed for completion in 5 seconds or under and/or using small sample volumes (for example, down to 1 μl or less). Such assays are described, for example, in U.S. Pat. No. 7,276,146 and U.S. Pat. No. 7,276,147, and others involve capillary chambers, microelectrodes or facing electrodes. Such assays have a less effective noise reduction, which renders ineffective the techniques taught in U.S. Pat. No. 5,243,516.

Accordingly, there is a need to provide an enhanced rejection regime to effectively reject erroneous results at relatively high noise levels.

### SUMMARY

This object and others that will be appreciated by a person of ordinary skill in the art have been achieved according to the embodiments of the present invention disclosed herein. In one embodiment, the present invention provides a method for determining the concentration of an analyte in a sample which comprises: a) performing an electrochemical test comprising: (i) contacting the sample with an electrochemical cell comprising at least two electrodes; and (ii) obtaining at least one group of three or more measurements of an electrochemical parameter from the cell, wherein each measurement in each at least one group is obtained at a different time; b) deriving from said at least one group of three or more measurements a single value that is indicative of the time-dependent behavior of the measured parameter; c) comparing the single value indicative of the time-dependent behavior of the measured parameter with a pre-determined range of acceptable time-dependent behaviors; d) determining whether the test is acceptable based on the result of said comparison; e) optionally repeating the above-mentioned steps; and f) determining the concentration of the analyte from the measurements obtained from the acceptable test or acceptable tests.

The embodiments of the invention also relate to a computer program for establishing whether a test to determine the concentration of an analyte in a sample is acceptable, the program comprising code means that, when executed by one or more data-processing devices, instructs the data-processing device to perform a method comprising: receiving measurement data representing at least one group of three or more measurements of an electrochemical parameter obtained from an electrochemical cell, wherein each measurement in each at least one group is obtained at a different time; deriving from the measurement data a single value indicative of the time-dependent behavior of the measured parameter; comparing the single value indicative of the time-dependent behavior of the measured parameter with a pre-determined range of acceptable time-dependent behaviors; and determining whether the test is acceptable based on the result of said comparison.

The embodiments of the invention still further provide an electrochemical device comprising: an electrochemical cell comprising at least two electrodes; a voltage source arranged to selectively apply a voltage across the cell: a measurement circuit arranged to obtain measurements of an electrochemical parameter on the cell; a calculating device arranged to calculate from at least one group of three or more measurements obtained by the measurement circuit, wherein each measurement in each at least one group is obtained at a different time, a single value indicative of the time-dependent behavior of the measured parameter; and a comparator arranged to compare the single value indicative of the time-dependent behavior of the measured parameter with a pre-determined range of acceptable time-dependent behaviors.

The embodiments of the present invention generally involve comparing the time-dependent behavior of a measured electrochemical parameter with a pre-determined range of acceptable time-dependent behaviors. If the time-dependent behavior of the parameter (as characterized by a single value) falls within the acceptable range, the measurements obtained from that test are accepted as reliable. Conversely, if the time-dependent behavior of the parameter obtained in a test falls outside the acceptable range, the measurements obtained from that test are rejected as faulty.

Optionally, further tests may be performed. For example, the first test may be faulty, in which case one or more further tests are required until an acceptable test has been obtained.

Alternatively, many tests may be performed to yield a data set of multiple measurements. This data set is then analyzed to eliminate any measurements which fall outside the acceptable range. Finally, the concentration of the analyte is determined from the measurements obtained from the acceptable test or acceptable tests.

An advantage of the present invention is that it allows for faulty measurements to be rejected by way of an automated and objective process. Thus, once the range of acceptable time-dependent behaviors for the measured parameter has been established, the method of the present invention can be carried out by a person with no particular expertise in the field of electrochemistry. For example, the present invention could be applied to a biosensor designed for operation by a medical practitioner.

A further advantage of the present invention is that it allows for rejection of faulty measurements of unknown concentrations of analyte, even if the faulty concentration measurement has a physically plausible value. Without the analysis provided by the present invention, a user would have seen no need to reject such faulty measurements, even if he or she was a person skilled in the field.

Yet another advantage of the present invention is that it allows for more reliable calibration data to be collected. Calibration data, measurements obtained for samples with known analyte concentrations, are required to determine concentrations from measurements obtained on test samples comprising unknown amounts of analyte. By applying the analysis provided by the present invention, these calibration measurements can be obtained with greater accuracy, since faulty tests can be readily identified and re-performed. The accuracy of subsequent concentration measurements on samples comprising unknown analyte concentrations, which are based on the calibrations, is of course thus substantially improved.

Unlike previous error analysis methods, the methods of the invention are suitable for use in electrochemical systems that are characterized by high noise-to-signal ratios, systems using small volumes of sample and systems in which measurements are made over a short time (including systems having more than one or all of these properties). The methods of the invention are also readily applied to any electrochemical test (not, for example, just being applicable to a system in which a measured current over time is in accordance with the Cottrell equation).

The present invention therefore provides a method with improved reliability for determining the concentration of an analyte in a sample.

The invention is to be explained in more detail by the following figures and examples.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 depicts a device according to one embodiment of the present invention.

FIG. 2 depicts experimental oxidation currents (in nA) obtained using filtered venous repeats versus triglyceride concentrations (in mMol) obtained using a SpAce analyser (Alfa Wasserman).

FIG. 3 depicts the experimental oxidation currents (nA) obtained using filtered venous repeats versus triglyceride concentrations (mMol) obtained using a SpAce analyser (Alfa Wasserman) as depicted in FIG. 2, but showing the data points removed using a rejection criterion.

FIG. 4 depicts experimental oxidation currents (nA) obtained using filtered venous repeats versus cholesterol concentrations (mMol) obtained using a SpAce analyser (Alfa Wasserman).

FIG. 5 depicts the experimental oxidation currents (nA) obtained using filtered venous repeats versus cholesterol concentrations (mMol) obtained using a SpAce analyser (Alfa Wasserman) as depicted in FIG. 4, but showing the data points removed using a rejection criterion.

FIG. 6A depicts the experimentally determined oxidation currents (nA) obtained using filtered venous repeats versus cholesterol concentrations (mMol) obtained using a SpAce analyser (Alfa Wassermann), showing the data points remaining after the application of different filtering techniques: ♦ Unfiltered data; ▴ Filtered using Ratioₒₓ only; ▪ filtered using Ratioₒₓ, and Ratio_{red}; Data filtered using Ratioₒₓ, Ratio_{red} and current_{red}.

FIG. 6B depicts the experimentally determined oxidation currents (nA) obtained using filtered venous repeats versus cholesterol concentrations (mMol) obtained using a SpAce analyser (Alfa Wassermann), showing the data points remaining after the application of different filtering techniques: ♦ Unfiltered data; ▴ Filtered using product of Ratioₒₓ and Ratio_{red} only; filtered using current_{red} and the product of Ratioₒₓ, and Ratio_{red}.

FIG. 7A depicts the experimentally determined oxidation currents (nA) obtained using filtered venous repeats versus triglyceride concentrations (mMol) obtained using a SpAce analyser (Alfa Wassermann), showing the data points remaining after the application of different filtering techniques: ♦ Unfiltered data; ▴ Filtered using Ratioₒₓ only; ▪ filtered using Ratioₒₓ and Ratio_{red}; Data filtered using Ratioₒₓ, Ratio_{red} and current_{red}.

FIG. 7B depicts the experimentally determined oxidation currents (nA) obtained using filtered venous repeats versus triglyceride concentrations (mMol) obtained using a SpAce analyser (Alfa Wassermann), showing the data points remaining after the application of different filtering techniques: ♦ Unfiltered data; ▴ Filtered using product of Ratioₒₓ and Ratio_{red} only; filtered using current_{red} and the product of Ratioₒₓ and Ratio_{red}.

FIG. 8 depicts the experimentally determined oxidation currents (nA) obtained using filtered venous repeats versus cholesterol concentrations (mMol) obtained using a SpAce analyser (Alfa Wassermann), showing the data points remaining after the application of different filtering techniques: ♦ Unfiltered data; ▴ Filtered using Ratioₒₓ only with 10-point filtering; ▪ filtered using Ratioₒₓ and Ratio_{red} both with 10-point filtering; Data filtered using Ratioₒₓ and Ratio_{red} both with 10-point filtering and current_{red}.

FIG. 9 depicts the experimentally determined oxidation currents (nA) obtained using filtered venous repeats versus cholesterol concentrations (mMol) obtained using a SpAce analyser (Alfa Wassermann), showing the data points remaining after the application of different filtering techniques: ♦ Unfiltered data; ▴ Filtered using 1/ln(time) fit; Data filtered using 1/ln(time) fit and current_{red}.

FIG. 10 depicts experimentally determined oxidation currents (nA) obtained using whole blood for finger-sticks versus triglyceride concentrations (mMol) obtained using a SpAce analyser (Alfa Wassermann), showing the data points remaining after the application of different filtering techniques: ◯ Unfiltered data; Δ Filtered using Ratioₒₓ only; filtered using Ratioₒₓ and Ratio_{red}; × Data filtered using Ratioₒₓ, Ratio_{red} and current_{red}.

FIG. 11 A depicts experimentally determined oxidation currents (nA) obtained using filtered venous repeats versus cholesterol concentrations (mMol) obtained using a SpAce analyzer (Alfa Wassermann), showing the data points remaining after the application of different filtering techniques: ♦ Unfiltered data; ▴ Filtered using statistical analysis applied to currentₒₓ data only: filtered using the combination of statistical analysis applied to currentₒₓ data and current_{red}.

FIG. 11B depicts experimentally determined oxidation currents (nA) obtained using filtered venous repeats versus cholesterol concentrations (mMol) obtained using a SpAce analyzer (Alfa Wassermann), showing the data points remaining after the application of different filtering techniques: ♦ Unfiltered data; ▴ Filtered using statistical analysis applied to currentₒₓ data only; filtered using the combination of statistical analysis applied to currentₒₓ data and

In order that the present invention may be more readily understood, reference is made to the following detailed descriptions and examples, which are intended to illustrate the present invention, but not limit the scope thereof.

### DETAILED DESCRIPTION OF EMBODIMENTS OF THE PRESENT INVENTION

The following descriptions of the embodiments are merely exemplary in nature and are in no way intended to limit the present invention or its application or uses.

The present invention is useful in the electrochemical analysis of an analyte comprised in a sample. Suitable samples include biological and non-biological substances, including water, beer, wine, blood, plasma, sweat, tears and urine samples. The sample is typically a liquid. Suitable analytes include transition metals and their salts, heavy metals, and physiological species such as enzymes, cholesterol, triglycerides, cations, anions, biomarkers and biological analytes of clinical interest. In some embodiments, the analyte is cholesterol, triglyceride or HDL cholesterol.

The Groups of Three or More Measurements

The method of the present invention involves performing an electrochemical test in which the sample is contacted with an electrochemical cell and at least one group of three or more measurements of an electrochemical parameter is obtained.

An electrochemical test in accordance with the present invention comprises (i) contacting the sample with an electrochemical cell comprising at least two electrodes; and (ii) obtaining at least one group of three or more measurements of an electrochemical parameter from the cell. Typically, the test therefore comprises a period of time before the measurements are obtained, during which the sample is contacted with the cell. The period after first contacting the sample with the cell but before beginning to obtain measurements can be 5 minutes or less and even 3 minutes or less, for example 2 minutes or less or 90 seconds or less. The period is typically at least 1 second, and typically is at least 10 seconds, for example 30 seconds or 1 minute. The test also comprises a period during which time the measurements of the electrochemical parameter are obtained. In one embodiment, for example, the measurements are obtained during a period when an electrochemical potential is applied to the cell.

Each measurement of the electrochemical parameter for each group is obtained at a different time. Within the present invention, a “group of three or more measurements” means a series of at least three measurements obtained from the cell within a certain time period. The three or more measurements in a particular group may be made at equally or unequally spaced intervals. Generally, the time at which each measurement is obtained is known. For example, the measurements may be made at equally spaced time intervals around a particular time point of interest. If more than one group of measurements is required, typically the time interval between groups of measurements is sufficiently large so that there is no overlap in time between the measurements belonging to one group and the measurements belonging to another group. Typically, every measurement obtained from the cell is obtained at a different, unique time (i.e., only one measurement is obtained at a particular time).

The three or more measurements of an electrochemical parameter in each group may, for example, provide measurements of current, voltage, or charge when a potential difference is applied across the cell. In one embodiment, the measurements take the form of current obtained when known potential differences are applied at known times across the cell (for example, using a current follower to quantify the current). The potential difference may, for example, take the form of a time-varying potential as described in WO2006030170, in which case the current flowing between the electrodes is sampled during a period where the time-varying potential applied to step the potential between an initial and a final potential has attained a substantially constant potential. In one embodiment of the present invention, the measurements are obtained by amperometry. Typically, once a potential has been applied to the system, the cell is not returned to an open cell potential until all of the measurements have been made.

Typically, from three to 1000 measurements of an electrochemical parameter are obtained for each group. A smaller number of measurements for each group can be taken, for example 100, and as few as 10. The use of few measurements, for example three measurements or up to 5 measurements, has an advantage in that it allows for the analysis steps in the method to be simplified. However, the use of a larger number of measurements, for example at least 10, at least 50. or at least 100, has an advantage in that it allows for an enhanced signal-to-noise ratio when the data are used in the methods of the invention. Thus, the minimum number of measurements for each group is about 10. typically at least 50 and can be up to at least 100.

The limits to the time period between the first and last measurements made on the cell in the present invention are not particularly constrained (i.e., the first measurement of the first group of measurements and the final measurement of the final group of measurements). The time between the first and last electrochemical measurements may thus be determined by the practical demands of the particular embodiment of the invention. For example, for an electrochemical measurement made on a biosensor, such as those disclosed in International Application No. PCT/GB06/004848 (which is published as WO 2007/072013) for detection of cholesterol and triglyceride concentrations in physiological samples, the potential is typically applied for from 0.01 seconds to 10 seconds, for example at least one second, for example up to 5 seconds. At longer times, factors such as convection and vibration may interfere with the analytical signal. At shorter times, charging currents may, amongst other factors, become significant. However, in particular shorter time periods could become more desirable in other embodiments of the present invention, allowing for a concentration measurement to be made even more rapidly.

Raw data” Measurements and “Intermediary” Values

Once the at least one group of three or more measurements have been obtained, a single value is derived that is indicative of the time-dependent behaviour of the measured parameter.

A single group of three or more measurements may be used directly as three or more “raw-data” measurements at times t₁, t₂, . . . tₗₐₛₜ (where tₗₐₛₜ is is the last time at which a measurement is required). A “raw data” measurement is a single, unprocessed (for example, unaveraged) measurement of an electrochemical parameter obtained from the cell. In one embodiment of the invention, the single value characterising the time-dependent behaviour of the parameter of interest is thus generated directly from the three or more raw-data measurements of one group. In another embodiment, raw-data measurements from each of two or more distinct groups of measurements may be used in combination to obtain the single value.

Alternatively, the single value can be obtained via two or more “intermediary values”. Each intermediary value can be understood as being a “noise-averaged” measurement. A particular group of measurements (or more than one group) may be converted into one intermediary value or more than one intermediary value. The number of intermediary values derived is typically fewer than the total number of measurements; furthermore, at least two intermediary values are required in this embodiment. Each intermediary value is derived from at least two “raw data” measurements.

Methods for calculating the one or more intermediary values characterising particular raw-data measurements (i.e., for noise-averaging the raw data measurements) are not particularly limited. In one embodiment, an intermediary value is calculated as a simple average or an appropriately weighted average of the corresponding raw data measurements. In another embodiment, a standard mathematical regression method is applied to the three or more measurements; here, the raw-data measurements are made at a plurality of times and a line-of-best-fit (such as a linear regression lit) is used to fit these data points. Once the fit is generated, a single intermediary value can readily be obtained at a particular time point of interest (for example, a time point substantially in the middle of the time period over which the three or more measurements have been made). Alternatively, two or more intermediary values could be obtained as positions along the line-of-best fit corresponding to two or more times of interest. In one such embodiment of the invention, from 2 to 5 intermediary values are obtained by applying linear regression fits to at least 10 raw-data-electrochemical measurements.

In embodiments where two or more intermediary values are obtained, the single value indicative of the time-dependent behaviour of the parameter of interest is generated not directly from the raw data measurements themselves, but indirectly via the plurality of intermediary values.

Parameterization of the Groups of Measurements

The single value indicative of the time-dependent behavior of the measured parameter is compared with a pre-determined range of acceptable time-dependent behaviors, at which point it is determined whether the test is acceptable. The test is acceptable if the single value is within the pre-determined acceptable range. To allow the analysis to take place, both the time-dependent behaviour of the measured parameter (as expressed through a single value) and the pre-determined range of acceptable time-dependent behaviours must be mathematically parameterised. The exact nature of this parameterisation is not particularly limited, beyond that for the measured parameter a single value is required.

When no intermediary values have been generated from the raw data points (i.e., the at least one group of three or more measurements), the single value is obtained from the raw data points themselves. For example, the shape of a current transient obtained from a single group of measurements could he used as the parameterisation, with that shape being fitted with either an empirical or a particular theoretical model and the quality of the tit, as expressed through a single value, determining whether a particular test is acceptable or faulty. In another embodiment where three or more measurements are used, the parameterisation could, for example, take the form of a statistical residual deviation of these measurements from a line-of-best-lit calculated for the plurality of measurements. In one such embodiment, the pre-determined acceptable range could take the form of an upper limit on a statistically-based parameter obtained in a test. Methods for deriving the statistically-based parameter are not particularly limited, beyond that they reflect in some way the statistical variance in the measured data. In one illustrative specific example, in a system where a group of three or more measurements corresponds to a plurality of measurements of current and where this current is expected to be constant, analysis could be based on the premise that the values of the plurality of measurements would be expected to follow a normal distribution. Deviations from a normal distribution are then indicative of erroneous outliers in the data. A single value characterising this property could readily be obtained, for example by obtaining the standard deviation of all of the data (i.e., including any erroneous outliers) and an estimate of the standard deviation obtained using just a more central portion of the data (i.e. excluding the outlying data). This estimate could be obtained, for example, by calculation of the difference between the 25th and 75th percentiles (namely, the interquartile range) divided by a standard value, 2^{1/2}, to obtain another standard indication of variance herein known as the equivalent standard deviation. Substantial differences in the two standard deviations would be indicative of erroneous time-dependent behaviour (the single value could thus be for example, a ratio which should equal one, or a difference which should equal zero). Thus, in a specific embodiment, the single value indicative of the time-dependent behaviour of the measured parameter is derived by comparing (for example taking the ratio of or difference between) the statistical variance (for example, the standard deviation) of said at least one group of three or more measurements and the statistical variance (for example, the same measure of variance) of said at least one group of three or more measurements, but excluding a portion of the measurements that represent statistical outliers. The portion excluded may, for example, be the data lying outside the interquartile range of the measurements.

In an embodiment where intermediary values have been generated from the raw data, the single value is typically obtained from these intermediary values. Methods for parameterizing the time-dependent behaviour of the system from these intermediary values can be the same as those described above in respect of using raw-data measurements. In one embodiment, the parameterisation takes the form of a ratio of two intermediary values (calculated from the same or different groups of three or more measurements). The pre-determined acceptable range then consists of an upper and lower limit on the ratio that is obtained in a test. In still further embodiments, the difference between two intermediary values or the sum of two or more such intermediary values is used as the parameterisation.

In one particular embodiment, at least two groups of three or more measurements of an electrochemical parameter are obtained from the cell, at least one intermediary value is calculated from each group to obtain at least two intermediary values, and the single value is derived from the at least two intermediary values.

In another embodiment, the parameterisation comprises applying two or more such ratios (for example, a first ratio of two intermediary values obtained at different times during a first time period of the applied potential and a second ratio of two intermediary values obtained at different times during a second time period of the applied potential). The plurality of ratios are then compared to a range of acceptable values as a single data set (i.e,, by combining the ratios in some way and comparing the combined parameter with a single range of acceptable values) or separately (i.e., a different set of acceptable values corresponding to each ratio).

It will be appreciated from the foregoing that there is no reason why the methods of the invention must involve only one comparison step. It is quite possible within the present invention that two or more single values, each obtained from at least one group of three or more measurements (for example, different groups) are generated. In that case, the method of the invention could comprise, in addition to comparing one single value with a corresponding pre-determined range of acceptable time-dependent behaviours, at least one further comparison—namely, between the at least one further single value and its corresponding pre-determined range of acceptable time-dependent behaviours. Thus, what is meant by using a “single value” indicative of the time-dependent behaviour of the system is that at least one group of three or more measurements (i.e., at least three values) is converted into a single value, which is then compared with a pre-determined range of acceptable time-dependent behaviours.

Accordingly, the present invention also provides a method as set out above which additionally comprises, immediately after said step d):

b2) deriving from said at least one group of three or more measurements a further single value:

c2) comparing said further single value with a further pre-determined range of acceptable time-dependent behaviours:

d2) determining whether the test is acceptable based on the result of said further comparison; and

g) optionally repeating said steps by deriving a still further single value, comparing it with a still further pre-determined range of acceptable time-dependent behaviors, and thus determining whether the test is acceptable.

There is no limitation on the number of such single values that can be used. For example, if there are four groups of three or more measurements, one intermediary value could be derived from each of the four groups, a first single value corresponding to the ratio of the first two intermediary values could be generated and a second value corresponding to the final two intermediary values could also be generated; in this case, the error analysis method would involve comparing both these single values, separately, to their corresponding pre-determined ranges of acceptable behaviours. In a further embodiment, a “dual potential step” is applied to the system and at least one group of measurements (for example, of current) is obtained both in the time period when a first potential (for example, an oxidative potential) is applied and a time period when a second potential (for example, a reductive potential) is applied. Single values corresponding to the time-dependent behaviour in both the first and second potential regions may be obtained and these compared, sequentially, with their corresponding range of acceptable time-dependent behaviours. In this case, the test is regarded as acceptable if both of the single values fall within the respective acceptable ranges. Alternatively, these two “single values” may be treated as two intermediary values and thus used to obtain just one single value (for example, by taking their ratio or their product). The use of a dual potential step of this type has advantages in that it can identify errors in a system that may not readily apparent from the behaviour of a current measurement at a single potential: for example, due to an insufficiency in the amount of redox mediator species present in the sample as a result of factors such as poor wet-up or complexation between components in the test sample.

Thus, in an embodiment of the invention, there is provided method for determining the concentration of an analyte in a sample which comprises:

performing an electrochemical test comprising: (i) contacting the sample with an electrochemical cell comprising at least two electrodes; and (ii) obtaining two groups of three or more measurements of an electrochemical parameter from the cell, wherein the first group of measurements is obtained at a first applied potential and the second group of measurements is obtained at a second applied potential;

deriving from said first group of three or more measurements a first single value that is indicative of the time-dependent behaviour of the measured parameter at the first applied potential;

comparing in a first comparison step said first single value with a pre-determined first range of acceptable time-dependent behaviours;

determining whether the test is acceptable based on the result of first comparison;

deriving from said second group of three or more measurements a second single value that is indicative of the time-dependent behaviour of the measured parameter at the second applied potential;

comparing said second single value in a second comparison step with a pre-determined second range of acceptable time-dependent behaviours;

determining whether the test is acceptable based on the result of said second comparison:

optionally repeating the above-mentioned steps; and

determining the concentration of the analyte from the measurements obtained from the acceptable test or acceptable tests, wherein an acceptable test is where the test is determined to be acceptable by both the first and second determination steps.

The Pre-Determined Range of Acceptable Time-Dependent Behaviours

The pre-determined range of acceptable time-dependent behaviours may be obtained with reference to calculations deriving from various electrochemical theories. For example, according to Electrochemical Methods: Fundamentals and Applications, A. J. Bard and L. R. Faulkner, John Wiley & Sons, New York. 2^{nd} Edition, 2001. Chapter 5. page 175 and to Journal of Electroanalytical Chemistry, Issue 217. 1987, pages 417-423, a simple theoretical equation exists for the amperometric current observed at a microband electrode at a given experimental time and applied potential. An equation such as this may be used, for example, to estimate the ratio of two amperometric currents obtained at different times. In one embodiment of the present invention, which is a method for detecting the concentration of analytes such as cholesterol and triglycerides from physiological samples, a microband electrode with a width of from 1 □m to 100 □m is used in the cell. Measurements of amperometric current, Ct₁ and Ct₂, are made at two times, t₁ and t₂, at a fixed oxidative or reductive potential. Convenient times between t₁ and t₂ are, for example, from 0.1 seconds to 10 seconds. For an oxidation reaction, the above references indicate that the amperometric current at a time t may be calculated from

Error! Objects Cannot be Created from Editing Field Codes.,

where Ct is the microband current, F is a constant, A is the electrode area, n is the number of electrons involved in the electrochemical reaction, Dₒₓ is the diffusion coefficient of the mediator. [Ox] is the concentration of the oxidizable redox material, w is the width of the microband electrode and i is the time. This equation may thus be used to calculate a theoretical ratio for the two amperometric currents, Ct₁ and Ct₂, at the two times:

Error! Objects Cannot be Created from Editing Field Codes.

For example, for a test on a biosensor comprising a microband electrode of width w=1.5×10⁻³ cm and a redox material with a diffusion coefficient of Dₒₓ=6.6×10⁻⁶ cm² s⁻¹, and with measurements of amperometric current being obtained at t₁=1 second and t₂=1.3 seconds,

Error! Objects Cannot be Created from Editing Field Codes.

A theoretical ratio obtained such as by the calculation above may thus be used as the basis for determining a pre-determined range of acceptable ratios. For example, empirical limits could be placed on how close to the theoretical ratio an experimentally measured ratio would have to he in order to be considered an acceptable test. In this case, the experimentally measured ratio would be the ratio of a first intermediary value reflecting the current at t₁=1 second and a second intermediary value reflecting the current at t₂=1.3 seconds. Each intermediary value could be obtained, for example, from its corresponding measurements by using an averaging technique around the appropriate times, or by fitting regression lines to the measurements and extrapolating to the currents at the appropriate times.

In one embodiment, the pre-determined range of acceptable time-dependent behaviours may correspond to behaviour substantially in accordance with the Cottrell equation. Typically, however, the pre-determined range of acceptable time-dependent behaviours corresponds to behaviour which is not substantially in accordance with the Cottrell equation.

Alternatively, the pre-determined range of acceptable time-dependent behaviours may be established entirely empirically. In one such empirical method, which may be used alone or in combination with the above-mentioned theoretical technique, a plurality of tests is undertaken on samples with known analyte concentrations. In each test, the analyte concentration in the cell is “determined” by obtaining at least one group of three or more measurements of an electrochemical parameter. Each test therefore results in a determination of the (already known) concentration while also providing a single value indicative of the time-dependent behavior of the measured electrochemical parameter. The user may determine which of the plurality of tests result in determinations of the concentration that are sufficiently close to the actual (already known) concentration. Thus, for tests producing an acceptable result, the time-dependent behaviors of the electrochemical parameter are known. Similarly, for tests that are not acceptable, the time-dependent behaviors of the parameter are also known. Consequently, an empirical indication of which time-dependent behaviors correspond either to acceptable or faulty results can be obtained. This can subsequently be used to determine the range of acceptable time-dependent behaviours to be used in the present invention.

One particular embodiment occurs when the single value indicative of the time-dependent behaviour of the measured parameter is obtained using statistical methods. In this case, the single value represents a deviation of behaviour of the measured data from a particular type of statistical behaviour (e.g., a deviation from normally distributed data about a constant value or a line of best fit). The pre-determined range of acceptable time-dependent behaviours can again be obtained either using theoretical methods (i.e., a range based around the statistical behaviour that would, under a particular theory, be expected for a specific system) or empirical methods (i.e., a range based around those statistical behaviours that are known from control experiments to give reliable indications of analyte concentration).

Once it has been determined whether the test is acceptable, the method of the present invention optionally involves repeating the above-described steps, i.e., performing one or more further tests. For example, in a first embodiment one acceptable test is required. Therefore, if the first test is rejected by the analysis as being faulty, it becomes necessary to perform one or more further tests until an acceptable test has been obtained. Once an acceptable test has been obtained, the analyte concentration can be determined using standard electrochemical methodology from the measurements obtained from that test. Alternatively, in a second embodiment a pre-determined number of tests (more than one) are performed, thus building up a data set, with each test being subjected to the data analysis. In this embodiment, at least one, but sometimes a plurality, of acceptable tests is obtained from the data set. The analyte concentration is then determined using standard electrochemical methodology from the measurements obtained for all of the acceptable tests.

Finally, the concentration of the analyte is determined from the measurements obtained from the acceptable test or acceptable tests. Typically, all of the measurements used in the data analysis steps are also used in the determination of the concentration.

A device according to one embodiment of the invention is depicted in FIG. 1. In this embodiment, the device comprises a strip [S] comprising four electrochemical cells [C] and an electronics unit [E], e.g. a hand-held portable electronics unit, capable of forming electronic contact with the strip [S]. The electronics unit [E] may, for example, house a power supply for providing a potential to the electrodes, as well as a measuring instrument for detecting an electrochemical response and any other measuring instruments required. One or more of these systems may be operated by a computer program.

The electrochemical cell may be a two-electrode, a three-electrode, a four-electrode or a multiple-electrode system. A two-electrode system comprises a working electrode and a pseudo reference electrode. A three-electrode system comprises a working electrode, an ideal or pseudo reference electrode and a separate counter electrode. As used herein, a pseudo reference electrode is an electrode that is capable of providing a substantially stable reference potential. In a two-electrode system, the pseudo reference electrode also acts as the counter electrode; in this case a current passes through it without substantially perturbing the reference potential. As used herein, an ideal reference electrode is an ideal non-polarisable electrode through which no current passes. In the method of the invention the at least one group of three or more measurements can be obtained using two-electrode, three-electrode, four electrode or multiple electrode system.

In one embodiment of the invention, the electrochemical cell is in the form of a receptacle. The receptacle may be in any shape as long as it is capable of containing a liquid which is placed into it. For example, the receptacle may be cylindrical. Generally, a receptacle will contain a base and a wall or walls that surround the base. Suitable embodiments of electrochemical cells in the form of receptacles are, for example, disclosed in WO03056319.

The present invention covers all electrode types. At least one electrode may be a macroelectrode. Furthermore, at least one electrode may be a microelectrode. Still further, at least one electrode may be a microband electrode. If at least one electrode is a microelectrode or a microband electrode, typically the working electrode is a microelectrode or a microband electrode.

For the purposes of this invention, a microelectrode is an electrode having at least one dimension that comes into contact with the sample that does not exceed 50 μm. For example, all dimensions in contact with the sample may he less than 50 μm. The microelectrodes of the invention may have a dimension that contacts with the sample that is macro in size, i.e. which is greater than 50 μm. A typical microelectrode of the invention one dimension of 50 μm or less and one dimension of greater than 50 μm (where the dimensions referred to are those in contact with the sample).

For the purposes of this invention, a microband electrode is defined as having one dimension more than 50 μm and one dimension less than 50 μm (where the dimensions referred to are those in contact with the sample). A microband electrode is present in the cell in the shape of a band.

In some cases it is advantageous to have the counter electrode and the working electrode separated by a distance of at least 50 μm. It is also important to appreciate that the time domain over which an electrochemical measurement is taken influences the form of the final result and thus must always be considered in each measurement. For example, it is well known that microelectrodes give fast responses due to the rapid decay of the charging current; this means that data should be collected at a rapid rate to ensure that there is no loss of information from the full data set. This rapid data sampling can mean that noise in these measurements is significant. Indeed, this is one reason why comparing two discrete data points, as described in U.S. Pat. No. 5,243,516, is not an appropriate means of error analysis, whereas the methods described herein do provide an appropriate means of error analysis.

Further details regarding electrochemical cells which can be used in the devices of the present invention can be found in WO2006000828.

The at least one group of three or more measurements of an electrochemical parameter obtained on the cell involve the oxidation, reduction, or both oxidation and reduction of a redox material. Thus, the step of performing an electrochemical test involves contacting the sample with an electrochemical cell, thus causing an electrochemical reaction of the redox material.

The redox material can be any material that is electroactive. Thus, for example, on insertion of the sample into the cell, an applied potential across the cell may cause an number of measurements to be taken either substantially simultaneously or in a step-wise fashion. In one aspect of this embodiment, the cells contain different reagent mixtures that allow for different analytes to be detected simultaneously from a single test sample.

This invention may be conveniently implemented using a conventional general purpose digital computer (e.g., CPU, microprocessor, microcontroller, FPGA, ASIC) programmed according to the teachings of the present specification, as will be apparent to those skilled in the computer art. Appropriate software coding can readily be prepared by skilled programmers based on the teachings of the present disclosure, as will be apparent to those skilled in the software art. The present invention may also be implemented by the preparation of application specific integrated circuits or by interconnecting an appropriate network of conventional component circuits, as will be readily apparent to those skilled in the art.

In a further specific embodiment, the present invention provides a method for determining the concentration of an analyte in a sample which comprises:

performing an electrochemical test comprising: (i) contacting the sample with an electrochemical cell comprising at least two electrodes; and (ii) obtaining two or more measurements of an electrochemical parameter from the cell at different times;

deriving from the measurements information indicative of the time-dependent behaviour of the measured parameter;

comparing the time-dependent behaviour of the measured parameter with a pre-determined range of acceptable time-dependent behaviours;

determining whether the test is acceptable based on the result of said comparison;

optionally repeating the above-mentioned steps; and

determining the concentration of the analyte from the measurements obtained from the acceptable test or acceptable tests.

Typically, the one of the electrodes is a working electrode having at least one dimension of less than 50 μm. The method may, for example, comprise obtaining two or more measurements of the current at different times when a potential difference is applied across the electrochemical cell. In one embodiment, the method comprises comparing the ratio, parameter(t₁)/parameter(t₂), of the measured parameter obtained at two different times, t₁ and t₂, with a pre-determined range of acceptable ratios.

Another aspect of this further embodiment is a computer program for establishing whether a test to determine the concentration of an analyte in a sample is acceptable, the program comprising code means that, when executed by one or more data-processing devices, instructs the data-processing device to perform a method comprising:

receiving measurement data representing two or more measurements of an electrochemical parameter obtained from an electrochemical cell at different times;

deriving from the measurement data information indicative of the time-dependent behaviour of the measured parameter;

comparing the time-dependent behaviour of the measured parameter with a pre-determined range of acceptable time-dependent behaviours; and

determining whether the test is acceptable based on the result at said comparison.

Yet another aspect of this further embodiment is an electrochemical device comprising:

an electrochemical cell comprising at least two electrodes;

a voltage source arranged to selectively apply a voltage across the cell;

a measurement circuit arranged to obtain measurements of an electrochemical parameter on the cell;

a calculating device arranged to calculate from two or more measurements obtained by the measurement circuit at different times information indicative of the time-dependent behaviour of the measured parameter; and

a comparator arranged to compare the information with a pre-determined range of acceptable time-dependent behaviours.

Typically, from 2 to 1000 measurements of an electrochemical parameter are obtained in this further embodiment. Alternatively, the number of measurements may be the same as the number of measurements in a group, as set out above. The two or more measurements can be obtained as a single group of measurements or as more than one group of measurements. Typically, the information indicative of the time-dependent behavior of the measured parameter is in the form of a single value.

### EXAMPLES

Handheld Biosensor Device

electrochemical reaction of the redox material to occur and a measurable current to be produced. The redox material may be the analyte itself. Alternatively, it may be a separate electroactive substance, which interacts with the analyte such that it is present in a concentration that is quantitatively related to the concentration of the analyte.

In embodiments where the redox material is a separate electroactive substance, the redox material may be mixed with the sample before it is contacted with the cell or it may be comprised in the cell before the sample is contacted with the cell. In the latter embodiment, the redox material may be dried. The redox material may be present alone or as a mixture with other compounds, such as buffers or further reagents that are involved in the interaction between the redox material and the analyte. For example, the mixture may further comprise an electrocatalyst, which catalyses a reaction between the analyte and the redox material. Examples of suitable mixtures of this type, which allow for determination of total cholesterol, triglyceride and HDL cholesterol concentrations, are described in detail in International Application No. PCT/GB06/004848 (which is published as WO 2007/07201 3).

The electronics unit [E] comprises a voltage source arranged to selectively apply a voltage across the cell and a measurement circuit arranged to obtain measurements of an electrochemical parameter on the cell. The unit also comprises a calculating device arranged to calculate from at least one group of three or more measurements obtained by the measurement circuit at different times a single value indicative of the time-dependent behaviour of the measured parameter. The calculating device may, for example, comprise a current follower. The unit also comprises a comparator arranged to compare the single value with a pre-determined range of acceptable time-dependent behaviours. Typically, this will involve a memory or a computer on which is stored a program capable of performing an algorithm to compare input data (single value indicative of the time-dependent behaviour of the measured parameter) with permanently stored data (the range of acceptable time-dependent behaviours) to produce a positive or negative result. The comparator therefore also comprises an apparatus for storing experimental data obtained from the calculating device. The unit may also comprise other features, such as a display panel to read out the result returned by the comparator and the analyte concentration in the case where the test is acceptable.

The devices of the present invention may comprise two or more (e.g. three or four) electrochemical cells. In such an embodiment, a plurality of strips may be may be used or the strip [S] may itself comprise a plurality of electrochemical cells. This embodiment allows a

A device of the type depicted in FIG. 1 and described in detail in PCT/GB06/004848 (which is published as WO 2007/072013), having four electrochemical cells comprised in the strip [S], was used. Each electrochemical cell comprised a carbon working electrode and a Ag/AgCl pseudo reference electrode. The volume of each cell was approximately 0.6 μl. Reagent mixtures were inserted into two of the cells for carrying out cholesterol and triglyceride concentration tests.

The reagent mixtures used were as follows. Batches of reagent mixture were made up in advance using the proportions specified below.

Cholesterol test (0.6 μL inserted into one electrochemical cell)

0.1 M TRIS buffer (pH 9.0)

50 mM MgSO₄

5% w/v glycine

1% w/v myo-inositol

3.5% w/v CHAPS

3.5% w/v DeoxyBigCHAPS

80 mM Ru(NH₃)₆Cl₃

8.8 mM thio-nicotinamide adenine dinucleotide (TNAD)

4.2 mg/ml putidaredoxin reductase (PdR)

3.3 mg/ml cholesterol esterase (ChE)

22 mg/ml cholesterol dehydrogenase (ChDH)

Triglyceride test (0.6 μL inserted into a different electrochemical cell)

0.1 M HEPBS buffer (pH9)

10 mM NH₄Cl

10% w/v glycine

1% w/v ectoine

1% w/v CHAPS

80 mM Ru(NH₃)₆Cl₃

18 mM thio-nicotinamide adenine dinucleotide (TNAD)

6.5 mg/ml diaphorase

45 mg/ml glycerol dehydrogenase

100mg/ml lipase

The remaining two cells of the device were not used in the Examples described below.

A 0.6 μl aliquot of the above mixtures was dispensed into the desired cell by hand. Once dispensed, the solutions were freeze-dried.

An aliquot (5 μl) of sample was applied to the strip. The samples used were anonymized plasma samples with known concentrations of cholesterol and triglyceride. The sensors were tested by chronoamperometry using an Autolab POSTAT 12 (Eco Chemie) attached to a multiplexer (MX452, Sternhagen Design) controlled by the GPES software.

### Example 1

### Cholesterol Sensor

Following application of the sample to the strip, a wet-up period was allowed to elapse to permit up-take of the reagents in the sample and reaction between the reagents and the sample. As used herein, the wet-up period is the time between the application of the sample to the strip and the application of an electrochemical perturbation.

Following the wet-up period, the chronoamperometry test was initiated using the multiplexer attached to the Autolab (t=0 seconds on initiation). The potential difference was stepped using the potential-stepping technique disclosed in WO2006030170. At t=112 seconds, the instrument performed an oxidation at +0.15 V vs. Ag/AgCl for 1.3 seconds, followed by a 1.3 second reduction at −0.45 V vs. Ag/AgCl. The resulting current data on the cell comprising the cholesterol test reagent mixture were recorded as 100 data points within the last 0.3 seconds of the 1.3 second period of the oxidative potential and 100 data points within the last 0.3 seconds of the 1.3 second period of the reductive potential. Linear regression fits were obtained to the data points for both the oxidative and reductive potentials. The noise-averaged currents obtained at 1 second and 1.3 seconds after the start of application of the oxidative potential were calculated from a linear regression fit to the first set of 100 data points. Similarly, the noise-averaged currents obtained at I second and. 1.3 seconds after the start of application of the reductive potential were calculated from a linear regression fit to the second set of 100 data points.

The comparator required that the ratio (ratioₒₓ) of the noise-averaged current at 1 second to that at 1.3 seconds after the start of application of the oxidative potential satisfied the criterion 1.0<ratioₒₓ<1.04. The comparator further required that the ratio (ratio_{red}) of the noise-averaged current at 1 second to that at 1.3 seconds after the start of application of the reductive potential satisfied the criterion ratio_{red}<1.12. The comparator further required that the noise-averaged current (current_{red}) at 1 second after the start of application of the reductive current satisfied the criterion −6200 nA <current_{red}<−3500 nA. The test therefore provided a measurement of the noise-averaged current at 1 second after the start of application of the oxidative potential (which is proportional to the concentration of cholesterol in the sample) and also gave an indication of whether the measurement was acceptable (if it satisfied all three criteria) or faulty (if it failed one or more criteria).

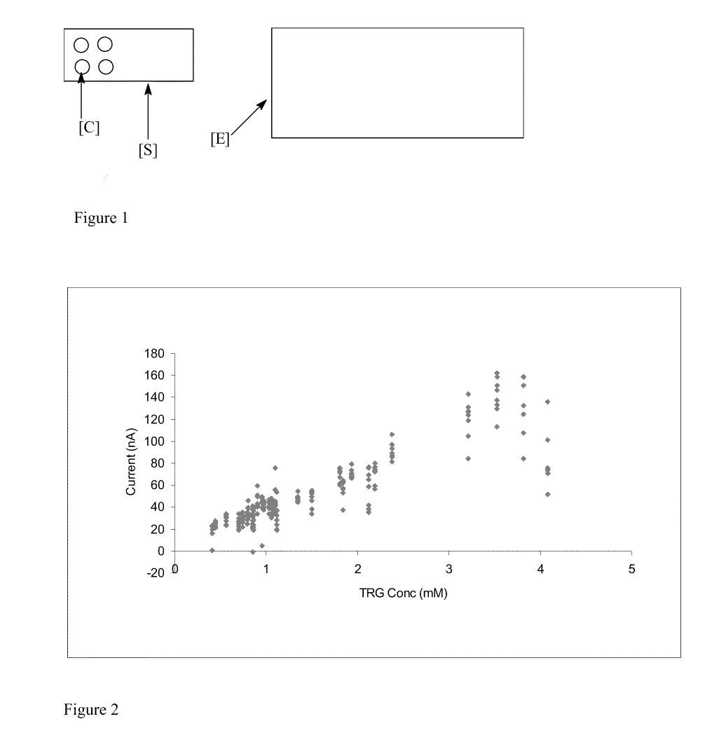

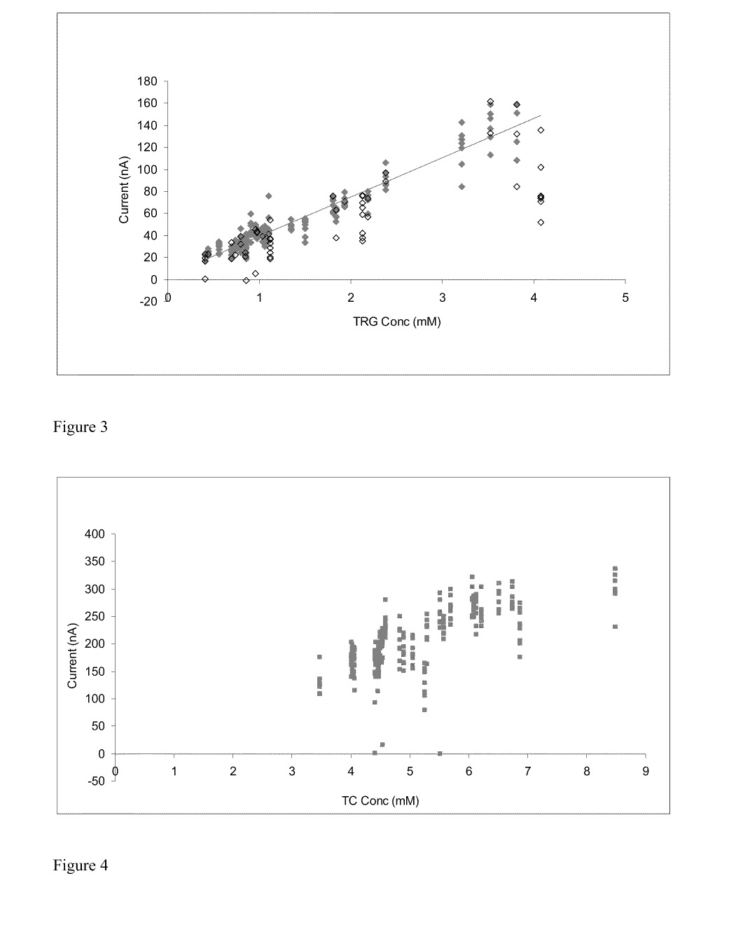

This procedure was repeated for several different plasma samples with a range of total cholesterol concentrations in order to obtain a calibration plot of current versus analyte concentration. The results are shown in FIG. 2 (without the data rejection analysis) and in FIG. 3 (with the data rejection analysis). The Figures show that the analysis allows data corresponding to faulty measurements (those for which an inaccurate measure of the correct cholesterol concentration has been made) to be rejected, resulting in a significant improvement in the accuracy of a measurement.

### Example 2

### Triglyceride Sensor

A series of tests were performed exactly as described in Example 1 above, except that the oxidative potential was applied instead at t=98 seconds and the current data were measured on the cell comprising the triglyceride test reagent mixture.

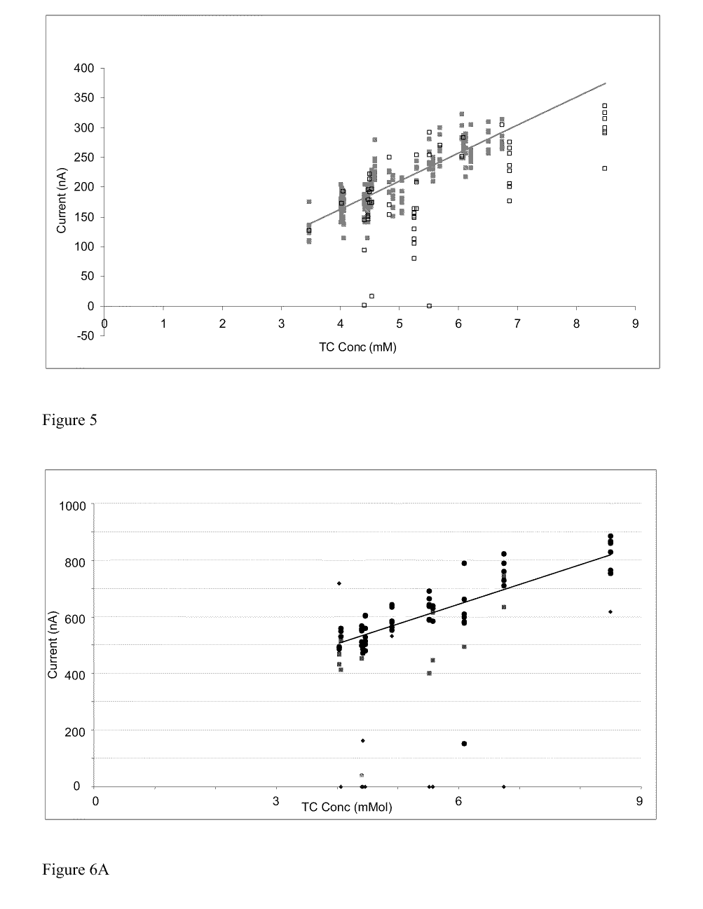

The results are shown in FIG. 4 (without the data rejection analysis) and in FIG. 5 (with the data rejection analysis). The Figures show that the analysis allows data corresponding to faulty measurements (those for which an inaccurate measure of the correct cholesterol concentration has been made) to be rejected.

### Examples 3 to 7

### Example 3

All of the experimental details are as for Example 1. However, in this Example the requirements of the comparator were adjusted as set out below.

points. Instead, the currents at 1 second and 1.3 seconds (for both the oxidative and reductive currents) were determined by averaging the 10 data points nearest to 1.0 and 1.3 seconds, respectively. These averaged currents were then used to calculate the current ratios.

The comparator required that the ratio (ratioₒₓ) of the noise-averaged current at 1 second to that at 1.3 seconds after the start of the application of the oxidative potential satisfied the criterion 1.012<ratioₒₓ<1.045. The comparator further required that the ratio (ratio_{red}) of the noise-averaged current at 1 second to that at 1.3 seconds after the application of the reductive potential satisfied the criterion ratio ratio_{red}<1.069. The comparator further required that the noise-averaged current (current_{red}) at 1 second after the start of the application of the reductive current satisfied the criterion −5700 nA <current_{red}<−2550 nA.

The results are shown in FIG. 8.

### Example 6

The experimental data are as for Example 1, but the determination of whether or not the data falls within acceptable limits has been completed by comparison to theory.

It was assumed that the current followed the form expected for a microband electrode, namely that the current is proportional to a function of ln(time). The data were analyzed by plotting the current against the product of the average current (currentₐᵥₑ) for the last 10 data points and the inverse of ln(time).

The slope of the resulting plot was then used to sort the data into acceptable and rejected. The comparator required that the slope of the plot satisfied the criterion 0.05<slope<0. In some cases, the comparator further required that the noise-averaged current (current_{red}) at 1 second after the start of the application of the reductive current satisfied the criterion −6000 nA <current_{red}<−3480 nA.

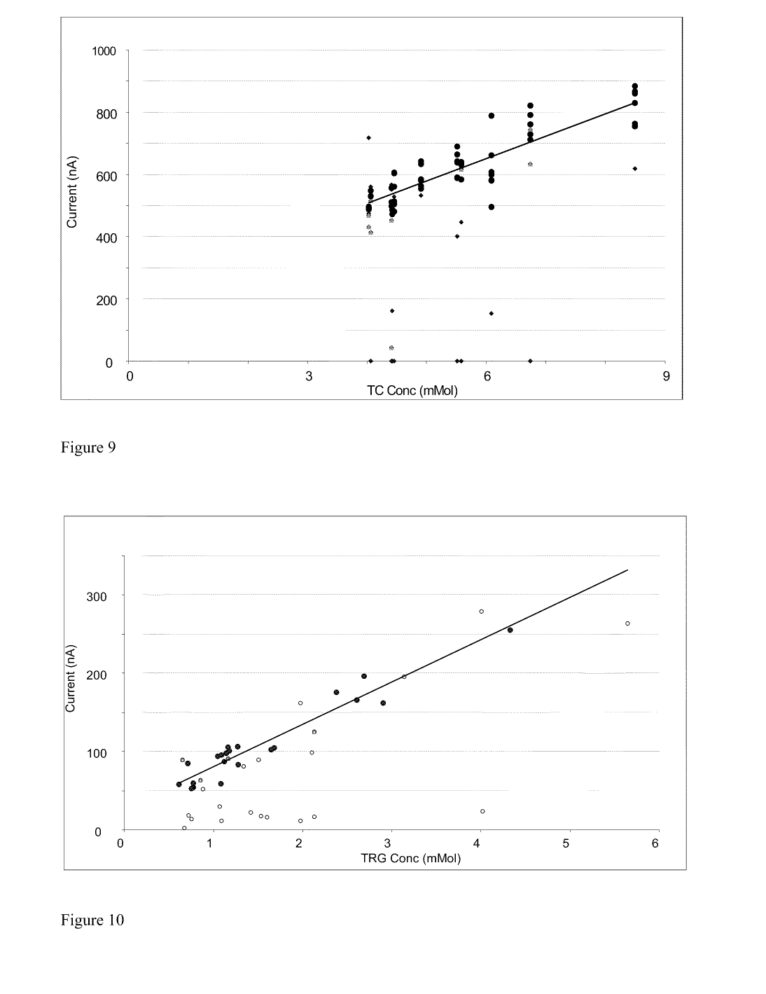

The results are shown in FIG. 9.

### Example 7

The experimental protocol was as shown for Example 1, excepting the following details:
A) The comparator required that the ratio (ratioₒₓ) of the noise-averaged current at 1 second to that at 1.3 seconds after the start of the application of the oxidative potential satisfied the criterion 0.980<ratioₒₓ<1.042. The comparator further required that the ratio (ratio_{red}) of the noise-averaged current at 1 second to that at 1.3 seconds after the application of the reductive potential satisfied the criterion 0.950<ratio_{red}<1.100. The comparator further required that the noise-averaged current (current_{red}) at 1 second after the stall of the application of the reductive current satisfied the criterion −6000 nA<current_{red}<−3480 nA.
B) Instead of using the two separate ratios set out in A), the comparator required that the product of these ratios satisfied the criterion 0.9850<ratioₒₓ×ratio_{red}<1.100.

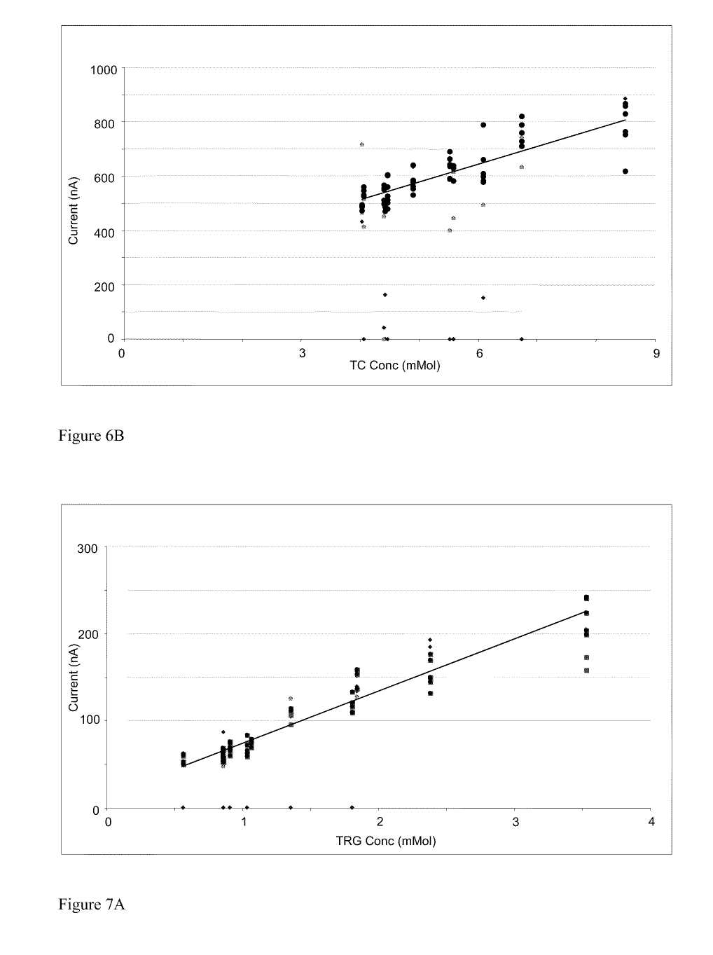

The results are shown in FIGS. 6A and 6B.

### Example 4

All of the experimental details are as for Example 2. However, in this Example the requirements of the comparator were adjusted as set out below.
A) The comparator required that the ratio (ratioₒₓ) of the noise-averaged current at 1 second to that at 1.3 seconds after the start of the application of the oxidative potential satisfied the criterion 1.012<ratioₒₓ<1.045. The comparator further required that the ratio (ratio_{red}) of the noise-averaged current at 1 second to that at 1.3 seconds after the application of the reductive potential satisfied the criterion ratio ratio_{red}<1.069. The comparator further required that the noise-averaged current (current_{red}) at 1 second after the start of the application of the reductive current satisfied the criterion −5700 nA<current_{red}<−2550 nA.
B) Instead of using the two separate ratios set out in A), the comparator required that the product of these ratios satisfied the criterion 0.9850<ratioₒₓ×ratio_{red}<1.100.

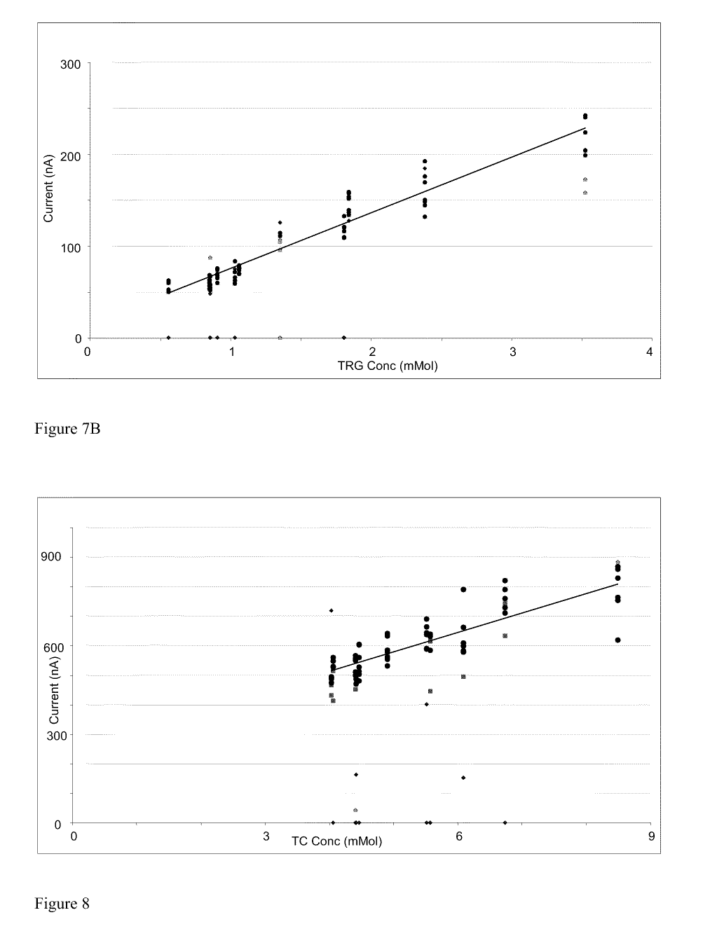

The results are shown in FIGS. 7A and 7B.

### Example 5

The experimental data are as for Example 1, but the determination of the ratios was completed in a different way. Specifically, linear regression was not used to fit the 100 data
The samples used were blood samples obtained directly by pin-pricking the fingers of volunteers (“linger-sticking”).
A wet-up period 98 seconds was allowed.
At 98 seconds, an oxidation at +0.15 V vs. Ag/AgCl was performed for 1.3 seconds, followed by a 1.3 second reduction at −0.45 V vs. Ag/Ag/Cl.

The comparator required that the ratio (ratioₒₓ) of the noise-averaged current at 1 second to that at 1.3 seconds after the start of the application of the oxidative potential satisfied the criterion 1.000ratioₒₓ<1.040. The comparator further required that the ratio (ratio_{red}) of the noise-averaged current at 1 second to that at 1.3 seconds after the application of the reductive potential satisfied the criterion ratio ratio_{red}<1.120. The comparator further required that the noise-averaged current (I_{red}) at 1 second after the start of the application of the reductive current satisfied the criterion −4200 nA<current_{red}<−3500 nA.

The results are shown in FIG. 10.

Analysis of Precision Improvements

Further analysis of the data from Examples 3 to 7 was undertaken by assessing the precision. % CV, of the readings at each analyte concentration in each of these Examples. The precision was calculated using the Formula

Error! Objects Cannot be Created from Editing Field Codes.,

where StDev is the standard deviation of the current measurements obtained during the oxidative potential from a given sample, and Average is their mean value. The AveCV % given in Tables 1 to 7 below represents an average (mean value) of the % CV values obtained over the whole data set (i.e., at all analyte concentrations).

TABLE 1
Data for Example 3, FIG. 6A: where N is the number of points.

| Process | N | Ave CV % |
|---|---|---|
| unfiltered | 88 | 39.0% |
| ratioₒₓ | 74 | 11.6% |
| ratioₒₓ and ratio_{red} | 77 | 8.6% |
| ratioₒₓ and ratio_{red} and | 60 | 6.3% |
| current_{red} | | |

TABLE 2
Data for Example 3. FIG. 6B; where N is the number of points.

| Process | N | Ave CV % |
|---|---|---|
| unfiltered | 88 | 39.0% |
| product of ratioₒₓ and ratio_{red} | 72 | 13.8% |
| product of ratioₒₓ and ratio_{red}, | 58 | 6.1% |
| and current_{red} | | |

TABLE 3
Data For Example 4, FIG. 7A: where N is the number of points.

| Process | | Ave CV % |
|---|---|---|
| unfiltered | 8 | 31.1% |
| ratioₒₓ | 2 | 9.7% |
| ratioₒₓ and ratio_{red} | 6 | 9.4% |
| ratioₒₓ and ratio_{red} and | 2 | 8.3% |
| current_{red} | | |

TABLE 4
Data for Example 4, FIG. 7B; where N is the number of points.

| Process | N | Ave CV % |
|---|---|---|
| unfiltered | 88 | 31.1% |
| product of ratioₒₓ and ratio_{red} | 73 | 14.4% |
| product of ratioₒₓ and | 66 | 8.5% |
| ratio_{red}, and current_{red} | | |

TABLE 5
Data for Example 5, FIG. 8; where N is the number of points.

| Process | N | Ave CV % |
|---|---|---|
| Unfiltered | 88 | 39.0% |
| ratioₒₓ (10 pnts) | 72 | 13.8% |
| ratioₒₓ and ratio_{red} (10 pnts) | 71 | 10.8% |
| ratioₒₓ and ratio_{red} (10 pnts) | 58 | 7.8% |
| and current_{red} | | |

TABLE 6
Data for Example 6, FIG. 9: where N is the number of points.

| Process | N | Ave CV % |
|---|---|---|
| unfiltered | 88 | 39.0% |
| Theoretical (Slope) | 63 | 11.3% |
| Theoretical (Slope) and | 51 | 5.9% |
| current_{red} | | |

TABLE 7
Data for Example 7, FIG. 10, where N, is the number of points. The RSQ
(square of the Pearson product moment correlation coefficient) is used in the place of Ave % CV
since each sample is in this case unique and multiple readings were not collected. The RSQ
parameter is therefore the simplest measure of improvement as a result of filtering.

| Process | N | RSQ |
|---|---|---|
| currentₒₓ | 44 | 0.511 |
| ratioₒₓ | 25 | 0.907 |
| ratioₒₓ, and ratio_{red} | 22 | 0.921 |
| ratioₒₓ, and ratio_{red} | 20 | 0.921 |
| and current_{red} | | |

### Example 8

The experimental data are as for Example 1, but the determination of the ratios was completed by statistical analysis. Firstly, the oxidation current data (currentₒₓ) data were analysed to determine which data fell between the 25th and the 75th percentile. The current values at these percentiles were used to calculate the interquartile range (i.e., current_{25th percentile}−current_{75th percentile}). The equivalent standard deviation (eqvSD) was then calculated as the interquartile range divided by 2^{1/2}. This is a first measure of the statistical variance of the data, which excludes anomalous outliers.

The actual standard deviation (actSD) was also calculated for the oxidation current data to provide a second measure of the statistical variance of the data. Since all data points were included, this measure includes any anomalous outliers.

The resulting eqvSD is then divided by actSD and multiplied by 100 to determine the percentage similarity between the two measures of variance. For perfectly normally distributed data, the percentage similarity should of course be 100%.

In the present Example, the comparator required that the percentage similarity was greater than 63.1%. In some cases, the comparator further required that the noise-averaged current (current_{red}) at 1.0 second after the start of the application of the reductive current satisfied the criterion −6000 nA<current_{red}<−3480 nA. Or alternatively the comparator further required that the that the ratio (ratioₒₓ) of the noise-averaged current at I second to that at 1.3 seconds after the start of the application of the oxidative potential satisfied the criterion 0.980<ratioₒₓ<1.042.

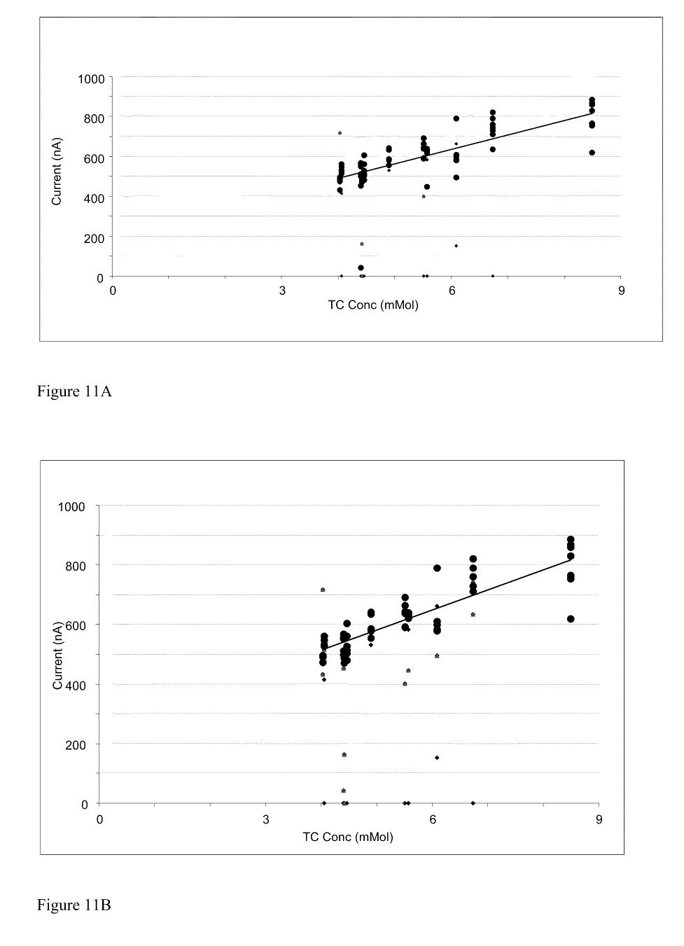

The results are shown in FIGS. 11A and 11B.

Further analysis of the data was undertaken by assessing the precision, % CV, of the readings using the approach set-out in respect of Example 3 to 7. The results are shown in Tables 8 and 9 below.

TABLE 8
Data for Example 8, FIG. 11A; whereN is the number of points.

| Process | | Ave CV % |
|---|---|---|
| Unfiltered | 8 | 38.9% |
| Statistical filtering of | 2 | 17.8% |
| currentₒₓ | | |
| Statistical filtering of | 7 | 11.2% |
| currentₒₓ, and current_{red} | | |

TABLE 9
Data for Example 8, FIG. 11B: where N is the number of points.

| Process | | Ave CV % |
|---|---|---|
| Unfiltered | 8 | 39.0% |
| Statistical filtering of | 2 | 17.8% |
| currentₒₓ | | |
| Statistical filtering of | 6 | 6.0% |
| currentₒₓ, and ratioₒₓ | | |

The features disclosed in the above description, the claims and the drawings may be important both individually and in any combination with one another for implementing the invention in its various embodiments.

It is noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the present invention in detail and by reference to specific embodiments thereof, it will be apparent that modification and variations are possible without departing from the scope of the present invention defined in the appended claims. More specifically, although some aspects of the present invention are identified herein as preferred or particularly advantageous, it is contemplated that the present invention is not necessarily limited to these preferred aspects of the present invention.

What is claimed is:

1. A method for determining the concentration of an analyte in a sample which comprises:
a) performing an electrochemical test comprising: (i) contacting the sample with an electrochemical cell comprising at least two electrodes; and (ii) obtaining at least one group of three or more measurements of an electrochemical parameter from the cell, wherein each measurement in each at least one group is obtained at a different time;
b) deriving from said at least one group of three or more measurements a single value that is indicative of the time-dependent behavior of the measured parameter;
c) comparing the single value indicative of the time-dependent behavior of the measured parameter with a pre-determined range of acceptable time-dependent behaviors;
d) determining whether the test is acceptable based on the result of said comparison; and
e) determining the concentration of the analyte from the measurements obtained from the acceptable test or acceptable tests.

2. The method according to claim 1, wherein at least one of said electrodes is a microelectrode or a microband electrode.

3. The method according to claim 1, wherein one of said electrodes is a working electrode having at least one dimension of less than 50 μm.

4. The method according to claim 1, wherein said at least one group of three or more measurements are obtained over a period of 5 seconds or less.

5. The method according to claim 1, wherein said sample has a volume of 1 μl or less.

6. The method according to claim 1, which comprises obtaining at least one group of three or more measurements of the current at different times when a potential difference is applied across the electrochemical cell.

7. The method according to claim 6, wherein said pre-determined range of acceptable time-dependent behaviors does not correspond to behavior substantially in accordance with the Cottrell equation.

8. The method according to claim 1, wherein said pre-determined range of acceptable time-dependent behaviors is obtained empirically or theoretically.

9. The method according to claim 1, wherein at least two intermediary values are calculated from said at least one group of three or more measurements; and said single value indicative of the time-dependent behavior of the measured parameter is derived from said at least two intermediary values.

10. The method according to claim 9, wherein each intermediary value is obtained by one of averaging two or more measurements and fitting two or more measurements using a mathematical regression method and deriving said intermediary value from the value of said regression fit at a pre-determined time point.

11. The method according to claim 9, wherein said single value is the ratio of two intermediary values.

12. The method according to claim 1, wherein said method additionally comprises, immediately after the step d), the steps of
b2) deriving from said at least one group of three or more measurements a further single value:
c2) comparing said further single value with a further pre-determined range of acceptable time-dependent behaviors;
d2) determining whether the test is acceptable based on the result of said further comparison; and
g) repeating, one or more times, steps b2), c2) and d2) by deriving a still further single value, comparing it with a still further pre-determined range of acceptable time-dependent behaviors, and thus determining whether the test is acceptable;
wherein in step f), a test is considered acceptable only if it is determined to be acceptable in step d) and step d2), and any optional still further determination steps performed according to step g).

13. The method according to claim 12, wherein the single value obtained in step b) is indicative of the time-dependent behavior of a measured current when a first potential, optionally an oxidative potential, is applied to the cell; said single value is the ratio of two intermediary values calculated from measurements obtained when said first potential is applied to the cell; and the further single value obtained in step b2) is indicative of the time-dependent behavior of a measured current when a second potential, optionally a reductive potential, is applied to the cell.

14. The method according to claim 13, wherein said further single value is the ratio of two intermediary values calculated from measurements obtained when said second potential is applied to the cell.

15. The method according to claim 13, wherein said further single value is the average value of at least one group of three or more measurements obtained when said second potential is applied to the cell.

16. A computer program for establishing whether a test to determine the concentration of an analyte in a sample is acceptable, the program comprising code means that, when executed by one or more data-processing devices, instructs the data-processing device to perform a method comprising:
a) receiving measurement data representing at least one group of three or more measurements of an electrochemical parameter obtained from an electrochemical cell, wherein each measurement in each at least one group is obtained at a different time;
b) deriving from the measurement data a single value indicative of the time-dependent behavior of the measured parameter;
c) comparing the single value indicative of the time-dependent behavior of the measured parameter with a pre-determined range of acceptable time-dependent behaviors; and
d) determining whether the test is acceptable based on the result of said comparison.

17. An electrochemical device comprising: an electrochemical cell comprising at least two electrodes; a voltage source arranged to selectively apply a voltage across the cell; a measurement circuit arranged to obtain measurements of an electrochemical parameter on the cell; a calculating device arranged to calculate from at least one group of three or more measurements obtained by the measurement circuit, wherein each measurement in each at least one group is obtained at a different time, a single value indicative of the time-dependent behavior of the measured parameter; and a comparator arranged to compare the single value indicative of the time-dependent behavior of the measured parameter with a pre-determined range of acceptable time-dependent behaviors.
